(19) United States
(12) Patent Application Publication
(10) Pub. No.: US 2026/0008174 A1
(43) Pub. Date: Jan. 8, 2026

(54) MOBILE ROBOTIC PLATFORM, PARTICULARLY DESIGNED TO MOVE BETWEEN TWO ROWS OF VINES

(71) Applicant: EXEL INDUSTRIES, EPERNAY (FR)

(72) Inventors: Thibault BACLE, LYON (FR); Jocelyn GAUTIER, LYON (FR); Vincent VIDAL, SAINT CYPRIEN (FR)

(73) Assignee: EXEL INDUSTRIES, EPERNAY (FR)

(21) Appl. No.: 19/256,571

(22) Filed: Jul. 1, 2025

(30) Foreign Application Priority Data
Jul. 2, 2024 (FR) 2407176

(51) Int. Cl. B25J 5/00; B25J 9/00; B25J 9/08

(52) U.S. Cl. CPC B25J 5/007; B25J 9/0009; B25J 9/08

(57) ABSTRACT

The invention aims at a mobile robotic platform comprising four wheels, a hollow chassis defining a chamber, at least one platform, placed above the chassis, with said platform defining at least two receiving areas, at least two masts connected to the chassis, the first mast protruding from the side of the chassis and the second mast protruding from the opposite side; the first mast extending into one of said receiving areas of said platform and the second mast extending into the other of said receiving areas of said platform; said platform being configured to receive on these receiving areas functional loads secured to said platform.

### TECHNICAL FIELD

This invention relates to the field of agricultural machinery and, in particular, autonomous agricultural machinery.

More specifically, the invention relates to a mobile robotic platform designed to move between two rows of vegetation, in particular vines, particularly between two narrow rows of vines.

### BACKGROUND

In viticulture, vine rows can have particularly narrow spacing, with an inter-row distance comprised between 0.9 m and 1.3 m, for example, about 1.2 m. It is known to work or harvest vine fruits using a straddling system. Such a system can treat, maintain the vines, or harvest the grapes. In the latter case, the straddling systems can be equipped to shake the vine stocks to drop the fruit and then transfer them to a storage container using a transfer system. The storage container moves parallel to the straddling system in an adjacent row of vines or in adjacent rows, and the transfer system extends between the straddling systems and the storage container above the vines.

However, such straddling systems, coupled with storage containers, are bulky and unsuitable for narrow vines. Moreover, these systems do not allow for the collection of grapes in whole bunches, which is particularly mandatory according to the Champagne specifications to obtain the designation of Champagne.

Thus, it is known to manually collect grape bunches in narrow vines, which is time-consuming and laborious for the person who must bend down, cut the grape bunch, stand up, and place it in a container, either carried on their back or nearby in the row.

Additionally, there are fruit-picking robots with a chassis connected to wheels or tracks to allow for movement between rows of plants. On the chassis, a robotic arm is configured to pick the fruit. Sometimes, the chassis can be connected to a cart configured to hold the fruit once picked.

However, this type of picking robot is not suitable for narrow vines, as they are too bulky and unsuitable for uneven terrains with slopes. Indeed, the cart, like the robotic arm, is configured to operate on regular and relatively flat ground.

Thus, the invention aims to solve the aforementioned problems by proposing a modular robotic platform designed to move between rows of vegetation, narrow vine rows in particular, adapted to uneven and sloped terrains, allowing for vine maintenance, whole grape bunch collection and storage, thereby facilitating, automating, and reducing the time and effort of collecting bunches of grapes between narrow rows of vegetation, vines in particular.

### SUMMARY

More specifically, the invention concerns a mobile robotic platform designed to move between two rows of vegetation, particularly vines, extending in length along a longitudinal axis, in width along a transverse axis, and in height along a vertical axis, said platform comprising four wheels, namely two left wheels and two right wheels; a hollow chassis defining a chamber, connected to the wheels, the left wheels being placed on one side of the chassis and the right wheels on the opposite side; at least one platform, placed above the chassis, said platform having at least two receiving areas, namely a first area and a second area; at least two masts connected to the chassis, namely a first mast and a second mast, the first mast protruding from the side of the chassis receiving the two left wheels along the vertical axis, in a direction opposite to the ground, and the second mast protruding from the opposite side along the vertical axis, also in a direction opposite to the ground.

According to the invention, the first mast extends into one of said receiving areas of said platform and the second mast extends into the other of said receiving areas; said platform being configured to receive, a functional load in each of these respective receiving areas, a respective container and a robotic arm in particular, with these functional loads being secured to said platform.

In particular, the robotic platform is autonomous between vine rows and allows for vine maintenance, picking, and/or storage of fruits, namely grape bunches, picked from the vines. Indeed, the wheels allow for robotic platform mobility between the vines, and the chassis, in particular the chassis chamber, allows for housing the wheel propulsion system that enables the movement of the robotic platform. The platform placed above the chassis chamber also allows for the attachment of a storage container for the collected fruit and/or a robotic arm for picking the fruit or maintaining the vines, for example. Each area of the platform can receive said container and/or said robotic arm, or any other functional load, as described below. The modularity of the robotic platform according to the invention is thus remarkable. Thus, the platform is adaptable to the needs of the user, whether for harvesting, maintenance, etc. Moreover, the masts protruding from the two receiving areas on opposite longitudinal and transverse sides of the chassis allow access to a first vine on one side of the robotic platform and also access to a second vine on another side of the robotic platform. Thus, harvesting and/or maintenance can be done simultaneously on the two vines between which the robotic platform moves, without requiring multiple passes or going back-and-forth. Furthermore, with the masts being able to extend above the vine vegetation, the platform is visible to a user located between the vine rows through which the robotic platform moves.

Advantageously, the platform is removable on said chassis.

The chassis chamber allows for housing the drive mechanism of the wheels that enables the movement of the robotic platform. By removing the platform placed above the chamber, the chamber and thus the drive mechanism can be accessed.

Advantageously, the platform comprises fastening units located on each side of the chassis, with these fastening units being configured to secure each mast to the platform and to secure said functional loads on said platform in the respective first area and the second area.

The fastening units may comprise threaded bores, for example, allowing for securing the functional loads by means of a screw system, in particular the container(s) on the platform and the robot(s) or robotic arms, on the platform. Once secured, the functional loads are securely connected to the robotic platform, preventing them from falling off the platform, even on uneven terrain, slopes, etc. The masts are secured to the platform by these fastening units. The fastening units then allow for a configuration adaptable to the user.

Advantageously, the robotic platform comprises at least two cameras, located on the chassis on a first transverse side and on a second transverse side of said chassis.

The cameras thus constitute the vision system of the robotic platform.

Advantageously, through holes are formed in the first area and the second area of the platform's receiving area.

Advantageously, through openings are formed in the first area and the second area of the platform's receiving area.

The through openings can help grasp the platform to facilitate its placement.

Advantageously, the chassis has a maximum width of 0.6 m along the transverse axis.

Such a width ensures the circulation of the robotic platform in narrow vines.

Advantageously, each mast has at least one control unit and at least one mast comprises a light indicator configured to indicate the location of the robotic platform.

The control unit allows for stopping the robotic platform, for example. The user can press an emergency stop button present on the mast, for example, causing the complete stop of the platform. The light indicator, located high above the ground on which the robotic platform moves and above the vine vegetation, allows a user to locate the robotic platform, even when it is moving between two rows of vines.

Advantageously, each mast has a height of between 1.2 m and 1.3 m, allowing in particular for clearing the control units from the vegetation, particularly the vine, and corresponding roughly to the average height of a human, with the control units thus being at an ergonomic height relative to the ground.

Thus, a human can access the mast and, by simply raising an arm and pressing a dedicated button on the control unit, cause the emergency stop of the platform. Moreover, such a mast height allows clearing the vegetation of antennas located in an upper part of the mast, allowing in particular for capturing radio signals, satellites, without obstruction by the vine vegetation.

Advantageously, each mast comprises two portions, namely a first portion and a second portion, each first portion protruding vertically along the vertical axis of the chassis in the direction opposite the wheels, each second portion protruding from the first portion in an inclined manner, towards the platform.

According to one embodiment, the robotic platform comprises handles, at the front and rear and on each side, arranged in the lateral faces of the chassis of the robotic platform, to allow for manipulation of the robotic platform.

According to one embodiment, the masts are foldable and can be folded towards the platform, in particular against the platform. This reduces the bulk of the robotic platform when not in use, in particular for storage or transport, for example via a utility vehicle.

### BRIEF DESCRIPTION OF THE DRAWINGS

The invention will be better understood by reading the following description, given solely as an example, and referring to the attached drawings, given as non-limiting examples, wherein identical references are given to similar objects and in which:

FIG. 1 is a schematic perspective representation of the robotic platform that is the subject of the invention, showing the chassis on which the platform is placed and the two diagonally opposed masts subjected;

FIG. 2 is a side view of the robotic platform of FIG. 1;

FIG. 3 is a view similar to FIG. 1, on which a container has been added to one of the receiving areas of the platform of the robotic platform;

FIG. 4 is a view similar to FIG. 3, on which a second container has been added to the other receiving area of the platform of the robotic platform;

FIG. 5 is a view similar to FIG. 4, with the containers here being crates;

FIG. 6 is a top view of the robotic platform of FIG. 1;

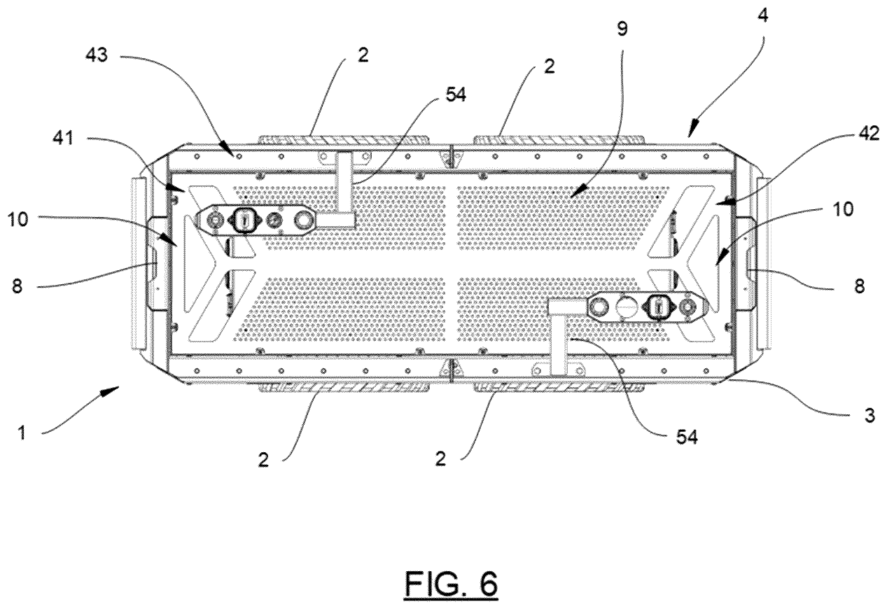

FIG. 7 is a front view of the robotic platform of FIG. 1 showing one of the navigation cameras of the robotic platform;

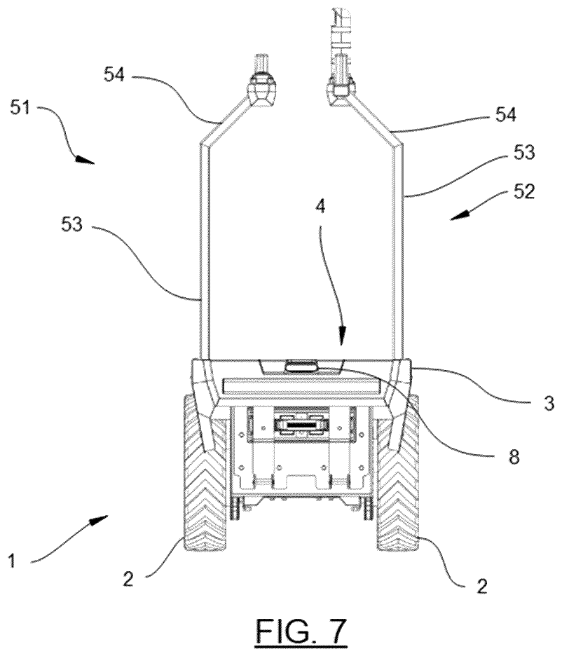

FIG. 8 is a view similar to FIG. 4, wherein a container has been replaced by a robotic arm;

FIG. 9 is a view similar to FIG. 8, wherein the container has been replaced by another robotic arm; and

FIG. 10 is a view similar to FIG. 1, with the platform having been removed to reveal the chamber defined in the chassis.

It should be noted that the figures present the invention in detail to enable the invention to be implemented; although not limiting, these figures serve in particular to better define the invention if necessary.

### DETAILED DESCRIPTION OF THE INVENTION

The invention relates to the field of agricultural machinery, and, in particular, the field of autonomous agricultural machinery.

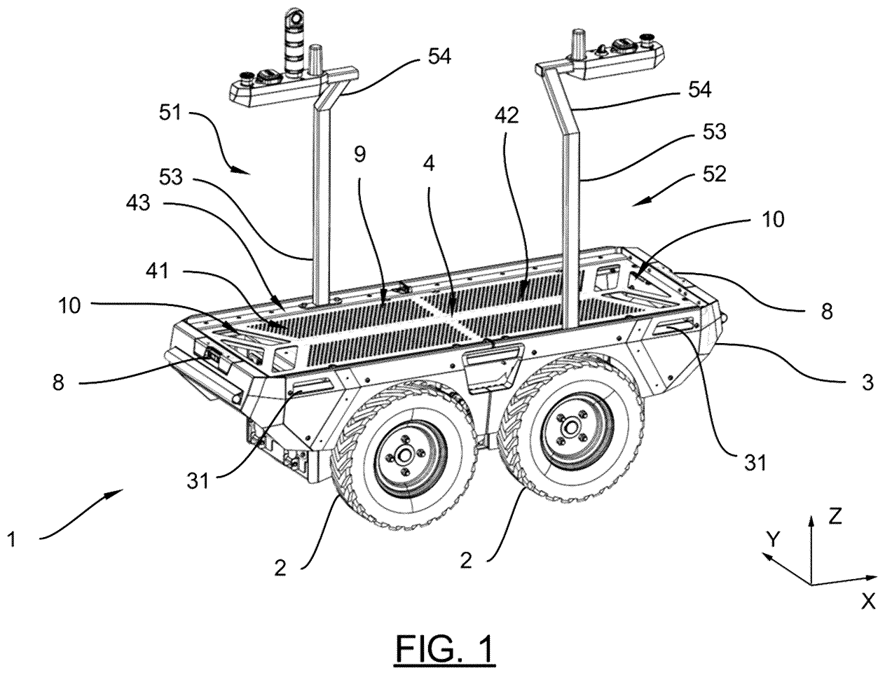

Referring to FIG. 1, the invention concerns a robotic platform 1 in particular. The robotic platform 1 is mobile and designed to move on the ground, between two rows of vines.

In particular, the robotic platform 1 is designed to move between two narrow rows of vines.

Narrow vines are understood as vines whose rows are spaced from 0.9 m to 1.3 m in particular, about 1.2 m, for example, from each other.

The robotic platform 1 extends in length along a longitudinal axis X, in width along a transverse axis Y, and in height along a vertical axis Z.

The robotic platform 1 comprises four wheels 2. In particular, the robotic platform 1 comprises two left wheels and two right wheels. The wheels 2 allow the mobility of the robotic platform 1 between the vines. The wheel size is designed in particular to allow for the use of standard agricultural tires adapted to the vine, and the overall mass of the robotic platform 1 is configured to allow for the use of these standard agricultural tires at low pressure, which protects the soil and maximizes the stability and crossing capabilities of the robotic platform 1.

The robotic platform 1 also comprises a chassis 3, at least one platform 4, and at least two masts 51, 52.

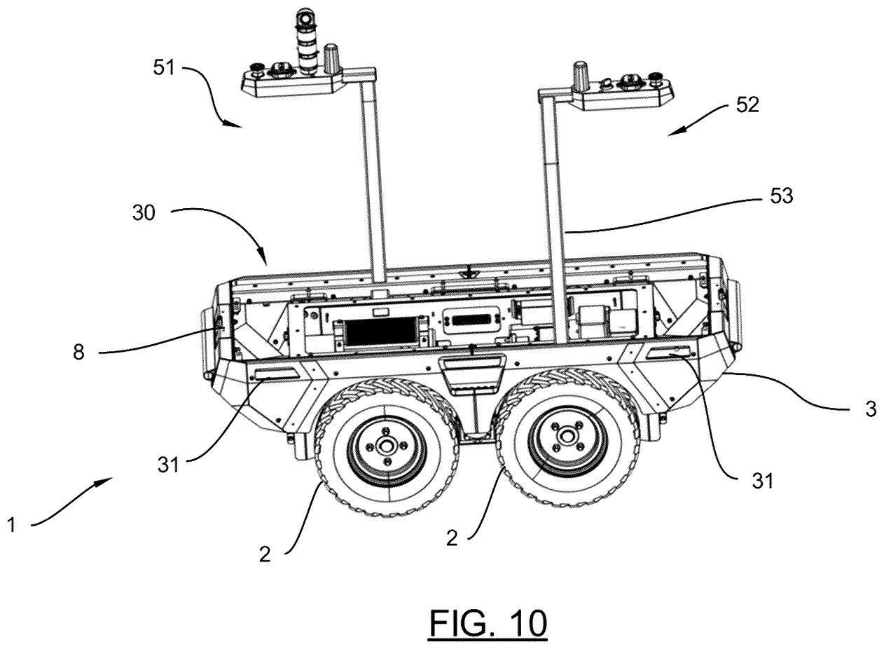

Referring to FIG. 10, the chassis 3 is hollow and defines a chamber 30. The chassis 3 is connected to the four wheels 2. In particular, the two left wheels are located on the same side of the chassis 3, and the two right wheels are located on the same other side of the chassis 3, opposite the side receiving the left wheels. Referring to FIG. 1, the left and right wheels are connected to the chassis 3, on each respective side of the robotic platform 1.

The chamber 30 of the chassis 3 allows for housing a drive mechanism for the wheels 2, enabling the mobility of the robotic platform 1 between the vines.

The chassis 3 preferably has a maximum width of 0.6 m along the transverse axis Y. Thus, it is compatible with narrow vines. Indeed, such a width ensures the circulation of the robotic platform 1 in narrow vines.

Referring to FIG. 1, the platform 4 is removable on the chassis 3 and is placed above the chamber 30 of the chassis 3.

The platform 4 positioned above the chamber 30 can prevent access to the drive mechanism of the robotic platform 1. Conversely, leaving access to the chamber 30 of the chassis 3 by removing the platform 4 can allow access to the drive mechanism and, for example, facilitate its maintenance.

In particular, the platform 4 has the shape of a longitudinally extending plate. The platform 4 here defines two receiving areas 41, 42, namely a first receiving area 41 and a second receiving area 42.

In the example shown in the figures, the first receiving area 41 and the second receiving area 42 have the same dimensions.

It is obvious that the first receiving area 41 and the second receiving area 42 can have different dimensions.

According to an unrepresented embodiment, the platform 4 may comprise more receiving areas along its length.

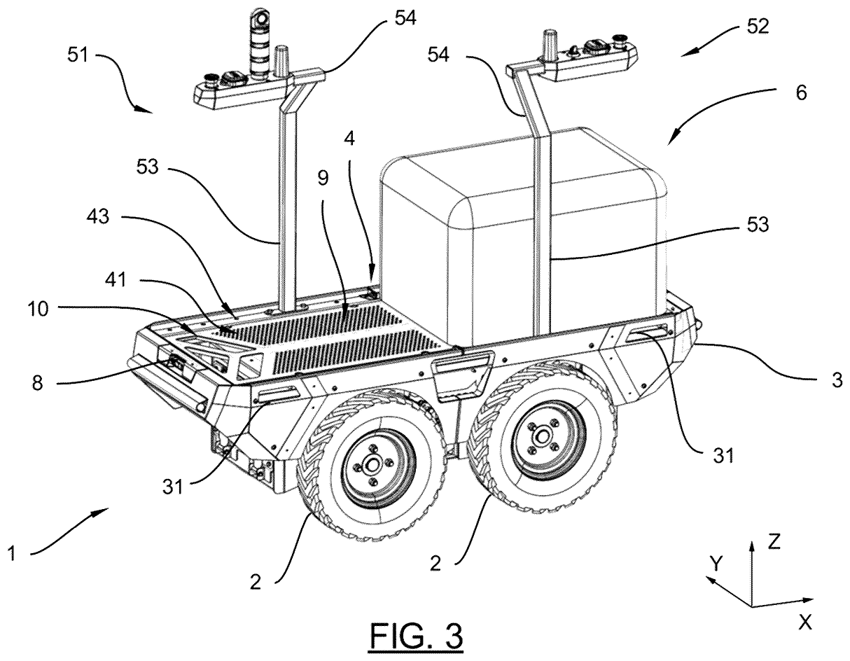

As shown in FIGS. 3, 4, 5, 8, and 9, the platform 4 is configured to receive a container 6 and/or a robot or a robotic arm 7 in these receiving areas 41, 42. The container 6, the robot, or the robotic arm 7 are attached to the platform 4. It goes without saying that the container 6, the robot, or the robotic arm 7 mentioned here and in the following description are examples of functional loads that can be received on the platform 4. A “functional load” means a useful load, having a specific function in particular in the context of the robotic platform that is the subject of the present invention. Other functional loads can be placed on the respective receiving areas 41, 42, and are interchangeable, allowing for increasing the modularity of the robotic platform.

Moreover, the robotic platform 1 according to the invention is particularly intended to operate between two rows of vines. However, it can also be used between two rows of vegetation other than vines. The robotic platform 1 according to the invention can also be used in open fields. The use of the robotic platform according to the invention is particularly advantageous in the case of vine rows and even more specifically in the case of narrow vines.

Thus, the platform 4 positioned above the chamber 30 prevents access to the drive mechanism.

Moreover, the platform 4 may comprise fastening units 43. The fastening units 43 are located on each of the longitudinal sides of the chassis 3. The fastening units 43 are configured to secure each mast 51, 52 to the platform 4 and to secure said containers 6 and/or robotic arms 7 on the platform 4 in the first area 41 and the second area 42 respectively.

In the embodiment represented in the figures, the fastening units 43 may comprise threaded bores, for example, allowing for attaching the container(s) 6 on the platform 4 and the robot(s) or robotic arm on the platform 4 by means of a screw system. Once attached, the container 6 and/or the robot is securely connected to the robotic platform 1 and its falling from the platform 1, even on uneven ground, on slopes, etc., is prevented.

Moreover, through holes 9 can be formed in the first area 41 and/or the second area 42 of the platform's receiving area 4.

The through holes 9 can help in grasping the platform 4 for placing it. Moreover, these through holes 9 also allow for the drainage of grape juice, if necessary, and preventing the accumulation thereof on the platform 4.

Moreover, through openings 10 can be formed in the first area 41 and/or the second area 42 of the platform's receiving area 4.

The openings 10 allow for grasping the platform 4. Thus, through these openings 10, the platform 4 can be placed above the chamber 30 or, conversely, the platform 4 can be removed to open the chamber 30 of the chassis 3.

Referring to FIG. 1, the two masts 51, 52 are connected to the chassis 3. In particular, a first mast 51 protrudes from the chassis 3, vertically, along the Z-axis, in the opposite direction of the wheels 2 and a second mast protrudes from the chassis 3, vertically, along the Z-axis, in the opposite direction of the wheels 2. The first mast 51 and the second mast 52 each protrude from one of the longitudinal sides of the chassis 3.

In particular, the first mast 51 extends into the first receiving area 41 or the second receiving area 42 of the platform 4, and the second mast 52 extends into the other receiving areas 42, 41 of the platform 4. In other words, the first and second masts 51, 52 protrude from the two receiving areas 41, 42 on opposite longitudinal and transverse sides of the chassis 3. The first mast 51 and the second mast 52 are diagonally opposed.

The masts 51, 52 are secured to the platform 4 by its fastening units 43. The fastening units 43 then allow for a configuration adaptable to the user.

The arrangement of the masts 51, 52 on the platform 4 allows for access to a first vine on one transverse side of the robotic platform 1 but also access to a second vine on another transverse side of the robotic platform 1. Thus, harvesting and/or maintenance can be done simultaneously on the two vines between which the robotic platform 1 moves, without requiring multiple passes or going back-and-forth. Furthermore, the masts 51, 52 protruding from the vine vegetation in height allow for access to the platform 1 by a user located between the vine rows, directly juxtaposed to the vine rows through which the robotic platform 1 moves.

Referring to the figures, each mast 51, 52 may have at least one control unit and at least one light indicator configured to indicate the location of the robotic platform 1.

The control unit allows for stopping the robotic platform 1, for example. The user can press an emergency stop button present on the mast 51, 52, for example, causing the complete stop of the platform 1. The light indicator, located at a height relative to the ground on which the robotic platform 1 moves and above the vine vegetation, allows a user to locate the robotic platform 1, even when it is in motion between two rows of vines.

Moreover, each mast 51, 52 has a height corresponding to the average height of a human. Thus, a human can access the mast 51, 52 and by simply raising their arm and pressing the control unit, allow the emergency stop of the platform 1. Moreover, such a mast height 51, 52 allows for clearing the vegetation of antennas located in an upper part of the mast 51, 52, allowing in particular the capture of radio and satellite signals.

According to one embodiment, each mast 51, 52 comprises two portions, namely a first portion 53 and a second portion 54, each first portion 53 protruding vertically along the vertical axis Z of the chassis 3 in the direction opposite the ground, and thus also opposite the wheels 2 resting on the ground. Each second portion 54 protrudes from the first portion 53 in an inclined manner, towards the platform 4. Each second portion allows for supporting the control unit for each mast 51, 52 in particular.

This inclination of the respective portions 54 of the masts 51, 52 allows for centering the emergency stop buttons present on the control units as much as possible, without encroaching on the loading surface of the platform 4 and without hindering the placement or grasping and carrying of a container 6, from the side, for example. This also allows for distancing the control units from the ground in case of the robotic platform 1 tipping over on a side.

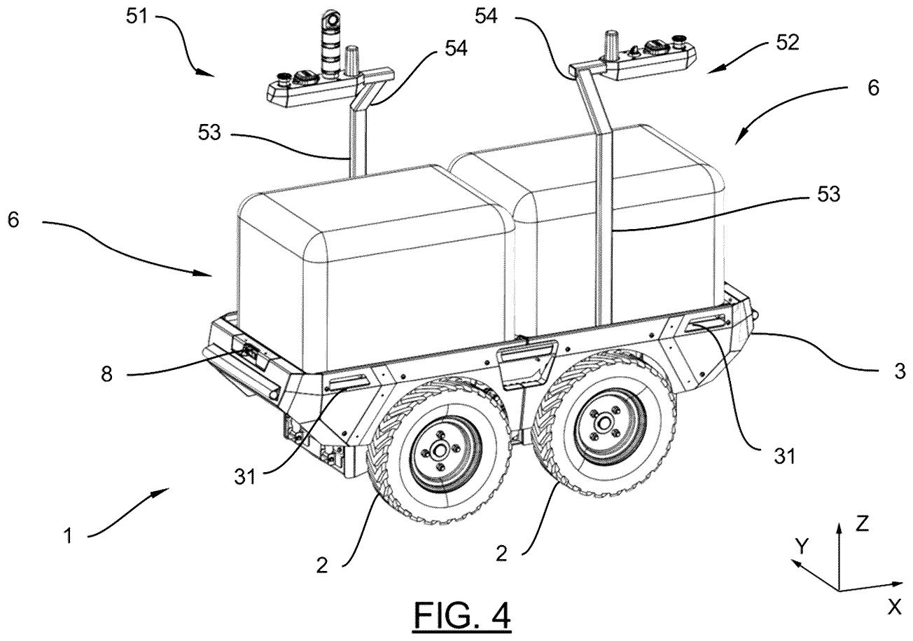

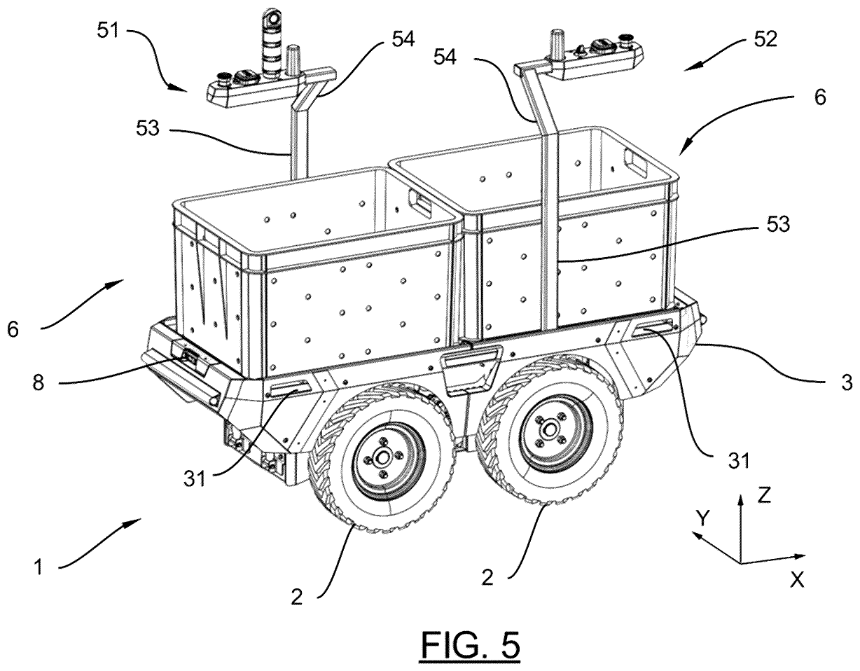

Referring to FIGS. 4 and 5, the robotic platform 1 can allow for the transport of two containers 6, one container 6 on each of the receiving areas 41, 42 of the platform 4. Such a configuration allows for interaction between the robotic platform 1 and one or more users. Indeed, the user picks the bunches of grapes from the vines and places them in the containers 6, with the robotic platform 1 then taking care of the storage and transport of the bunches picked along the vines. The arrangement of the masts 51, 52 allows for placement of the bunches in the containers 6 placed on the robotic platform 1, both from the front, from the rear, or from each side of the platform.

Moreover, according to an unrepresented embodiment, the masts 51, 52 are foldable and can be folded towards the platform 4, in particular against the platform 4. Once the masts are folded, the robotic platform presents a reduced bulk and can thus be more easily transported, in particular by being housed in a utility vehicle. For example, the masts 51, 52 can be secured against the platform 4 by adapted fastening units so that the masts are foldable towards the platform. The fastening units 43 are pivot joints, for example, that can be locked during the effective use of the robotic platform 1 and unlocked, thus allowing the masts 51, 52 to be folded against the robotic platform 1 when it is not in use and must be stored, in particular housed in a utility vehicle.

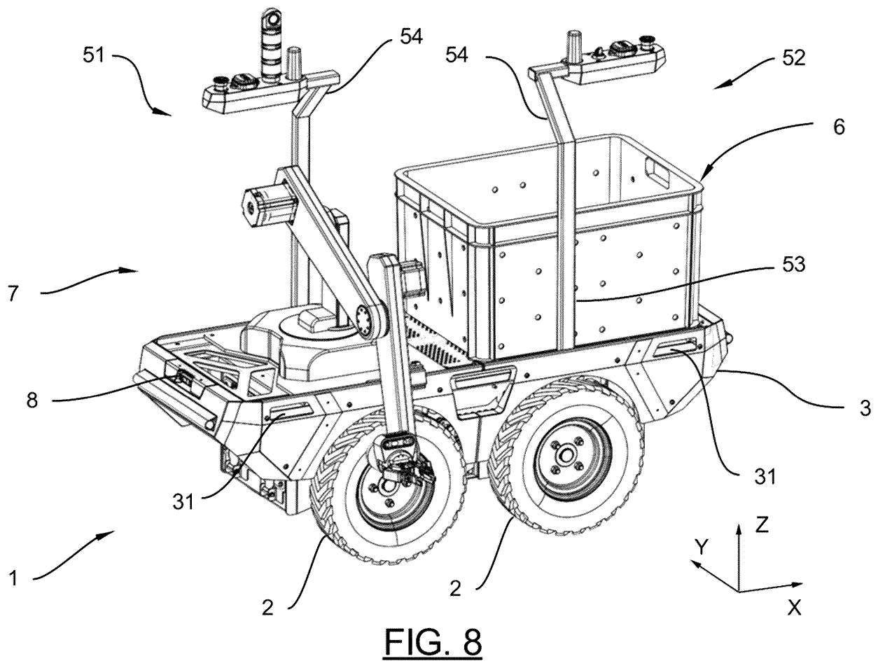

Referring to FIG. 8, a robotic arm 7 can be attached to the first receiving portion 41 of the platform 4, and a container 6 can be attached to the second receiving portion 42 of the platform 4. The robotic arm 7 can, for example, comprise a pruner and/or a gripper, allowing to pick the bunches from the vines, then place them in the container 6. Thus, such a configuration allows autonomous picking and transport of grape bunches across the entire vine.

According to one embodiment, the robotic arm 7 can be equipped with a gripper allowing to pick up containers 6 placed on the ground and transfer them onto the platform 4. Thus, with such a configuration, the robotic platform 1 would allow the collection of containers 6 and then their transport.

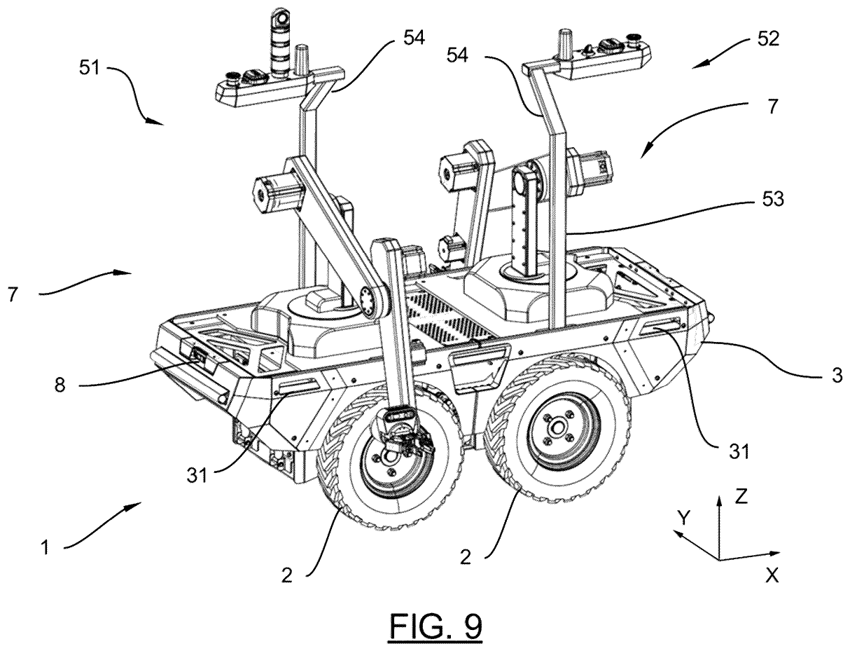

Referring to FIG. 9, a robotic arm 7 can be attached to the first receiving portion 41 of the platform 4, and another robotic arm 7 can be attached to the second receiving portion 42 of the platform 4. Such a configuration allows for maintenance of two adjacent vines autonomously and simultaneously.

It is clear that multiple configuration combinations are possible and that only a part is listed here. Various functional loads can be envisaged, in particular various robotic arms, allowing harvesting, maintenance on the row or inter-row, and/or the collection of containers 6 associated with another similar or different robotic arm 7, i.e., presenting other functionalities. Combining any of the possible robotic arms 7 with a container 6 may also be envisaged, to allow a user a variety of tasks and thus best adapt to their needs.

The containers 6 are particularly standard viticultural harvest crates. When a first receiving area receives such a standard viticultural harvest crate, the robotic platform according to the invention then embarks a standard viticultural harvest crate transport module. If the other receiving area of the platform 4 receives a harvesting robotic arm capable of picking up and placing the container on the first receiving area, then the robotic platform according to the invention then embarks a standard viticultural harvest crate collection module.

A receiving area of the platform 4 can be equipped with a robotic arm 7 comprising a pruning/gripping tool. In this case, it is said that the robotic platform according to the invention embarks a vine row maintenance robotic module.

A receiving area of the platform 4 can be equipped with a robotic arm 7 comprising a harvesting pruner/gripper. In this case, the robotic platform according to the invention embarks a harvesting robotic module.

A receiving area of the platform 4 can be equipped with a de-budding tool. In this case, the robotic platform according to the invention embarks a de-budding robotic module.

A receiving area of the platform 4 can be equipped with a plant shredding system. In this case, the robotic platform according to the invention embarks a plant shredding module.

A receiving area of the platform 4 can be equipped with a lifting/tool holder system. In this case, the robotic platform according to the invention embarks a lifting/tool holder module.

A receiving area of the platform 4 can receive one or more additional batteries. In this case, the robotic platform according to the invention embarks an additional battery module.

These different modules can be freely combined to obtain numerous configurations. For example, in a “collaborative transport” configuration, the robotic platform can embark two transport modules, in other words, two containers 6, in particular two standard viticultural harvest crates, with each container 6 being received in a respective receiving area, while, on each side of the platform, a human harvests the grapes to place them in one of the containers, the most accessible for them, the robotic platform being otherwise configured to move to accompany the movement of the harvesting humans.

In a “crate transport and collection” configuration, the robotic platform can be equipped with standard viticultural harvest crate collection modules.

In an “autonomous harvesting” configuration, the robotic platform is equipped with a harvesting robotic module and a standard viticultural harvest crate transport module.

In an “autonomous harvesting and unloading” configuration, the robotic platform is equipped with a harvesting robotic module and a standard viticultural harvest crate collection module.

In an “autonomous pruning” configuration, the robotic platform is equipped with two vine row maintenance robotic modules, in particular working in parallel on the rows located on either side of the robotic platform.

In an “autonomous pruning and shredding” configuration, the robotic platform is equipped with a vine row maintenance robotic module and a plant shredding module.

In an “autonomous inter-row maintenance” configuration, the robotic platform is equipped with a lifting/tool holder module and an additional battery(ies) module.

All the above examples are given for illustrative purposes and demonstrate the modularity of the robotic platform according to the invention.

The robotic platform 1 may also comprise at least two cameras 8, located on the chassis 3 on a first transverse side and on a second transverse side. The cameras 8 constitute the vision system of the robotic platform 1.

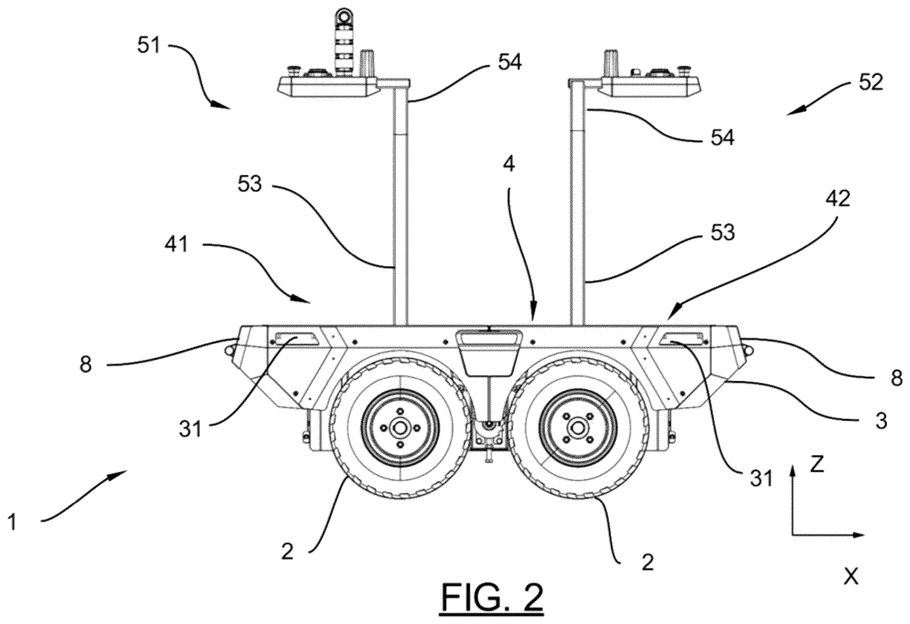

Moreover, as visible in FIGS. 1 to 5 and 8 to 10, the robotic platform 1 may comprise handles 31, at the front and rear and on each side, arranged in the lateral faces of the chassis 3 of the robotic platform 1, to allow the manipulation of the robotic platform 1. This allows users to manipulate the robotic platform 1 to assist it in difficult situations (slope, hollow, slope, etc.), for example.

The handles 31 may be in the form of lateral openings provided in covers forming the lateral faces closing the chassis 3 of the robotic platform 1.

An electrical interface comprising electrical connectors may be provided at the chassis level to allow for electrical connection and communication with functional loads and/or external additional batteries, to electrically connect them to equipment or a power distribution module housed in the chassis, as well as to allow fort the exchange of measurements or commands with a main controller also housed in the chassis.

It should also be noted that the invention is not limited to the embodiments described above. It will indeed appear to the skilled person that various modifications can be made to the embodiment described above, in light of the teaching that has just been disclosed.

In the detailed presentation of the invention made above, the terms used should not be interpreted as limiting the invention to the embodiment presented in this description, but should be interpreted to include all equivalents whose provision is within the reach of the skilled person by applying their general knowledge to the implementation of the teaching just disclosed.

1. A mobile modular robotic platform designed to move on the ground between two rows of vegetation, vines in particular, extending in length along a longitudinal axis, in width along a transverse axis, and in height along a vertical axis, said platform comprising:
four wheels, namely two left wheels and two right wheels;
a hollow chassis defining a chamber, connected to the wheels, the left wheels being placed on one side of the chassis and the right wheels being placed on the opposite side of the chassis to the side receiving the left wheels;
at least one platform, placed above the chassis, said platform defining at least two receiving areas, namely a first area and a second area;
at least two masts connected to the chassis, namely a first mast and a second mast, the first mast protruding from the side of the chassis receiving the two left wheels along the vertical axis, in a direction opposite to the ground, and the second mast protruding from the opposite side along the vertical axis, also in a direction opposite to the ground;
the first mast extending into one of said receiving areas of said platform and the second mast extending into the other of said receiving areas of said platform;
said platform being configured to receive, on each of these respective receiving areas, a functional load, in particular a container and/or a robotic arm respectively, said functional loads being secured to said platform,
wherein each mast has at least one control unit and at least one mast comprises a light indicator configured to indicate the location of the robotic platform.

2. The robotic platform according to claim 1, wherein the platform is removable on said chassis.

3. The robotic platform according to claim 1, wherein the platform comprises fastening units located on each side of the chassis, said fastening units being configured to secure each mast to the platform and to secure said functional loads on said platform in the respective first area and the second area.

4. The robotic platform according to claim 1, comprising at least two cameras, located on the chassis on a first transverse side and on a second transverse side of said chassis.

5. The robotic platform according to claim 1, wherein through holes are formed in the first area and the second area of the platform's receiving area.

6. The robotic platform according to claim 1, wherein through openings are formed in the first area and the second area of the platform's receiving area.

7. The robotic platform according to claim 1, wherein the chassis has a maximum width of 0.6 m along the transverse axis.

8. The robotic platform according to claim 1, wherein each mast has a height corresponding to the average height of a human.

9. The robotic platform according to claim 1, wherein each mast comprises two portions, namely a first portion and a second portion, each first portion protruding vertically along the vertical axis of the chassis in the direction opposite the wheels, each second portion protruding from the first portion in an inclined manner, towards the platform.

10. The robotic platform according to claim 1, comprising handles, at the front and rear and on each side, arranged in the lateral faces of the chassis of the robotic platform, to allow the manipulation of the robotic platform.

11. The robotic platform according to claim 1, wherein a receiving area is configured to receive a container and a receiving area receives a robotic arm.

12. The robotic platform according to claim 1, wherein the masts are foldable and can be folded towards the platform, in particular against the platform.
